(19) United States
(12) Patent Application Publication
(10) Pub. No.: US 2022/0285769 A1
(43) Pub. Date: Sep. 8, 2022

(54) BATTERY HOUSING

(71) Applicant: Mahle International GmbH, Stuttgart (DE)

(72) Inventors: Ingo Haeusler, Esslingen (DE); Dierk Hoffmann, Leonberg (DE); Ruediger Knauss, Kernen i.R. (DE); Peter Ruppricht, Esslingen (DE)

(21) Appl. No.: 17/685,375

(22) Filed: Mar. 2, 2022

(30) Foreign Application Priority Data
Mar. 3, 2021 (DE) 10 2021 202 065.8

(51) Int. Cl. H01M 50/204; H01M 50/231; H01M 50/224; H01M 50/227; H01M 50/249

(52) U.S. Cl. CPC H01M 50/204; H01M 50/231; H01M 50/224; H01M 50/227; H01M 50/249; H01M 2220/20

(57) ABSTRACT

A battery housing for accommodating battery cells of a battery may include at least two housing parts delimiting an inner volume. Each housing part of the at least two housing parts may have a connecting section. The connecting sections of the at least two housing parts may rest on one another. The at least two housing parts may be connected to one another via the connecting sections. Each housing part may have a plastic base body and a metal layer disposed on the base body for electromagnetic shielding of the inner volume. The metal layer may extend into the connecting section of the corresponding housing part such that the metal layers, in the connecting sections resting on one another, contact each other along an extension of the connecting sections.

### CROSS-REFERENCE TO RELATED APPLICATIONS

This application claims priority to German Patent Application No. DE 10 2021 202 065.8, filed on Mar. 3, 2021, the contents of which is hereby incorporated by reference in its entirety.

### TECHNICAL FIELD

The present invention relates to a battery housing for accommodating battery cells of a battery, which has at least two housing parts that delimit an inner volume of the battery housing. The invention also relates to a battery with such a battery housing.

### BACKGROUND

Batteries are used to deliver stored electrical energy and are used in a variety of ways. For this purpose, batteries have a battery housing in which at least one battery cell is accommodated. The battery cells are often rechargeable, so that the battery as a whole can be recharged. The battery housing serves, among other things, to protect the battery cells.

Such battery housings are usually made of a metal or metal alloy. The battery housings are therefore complex and/or expensive to produce. In addition, this can lead to undesirable electrical and/or electromagnetic interactions between the battery housing and the battery cells. This requires separate electrical insulation of the battery housing from the battery cells.

The use of battery housings made of plastic offers the advantage that said interactions do not occur. In addition, such battery housings can be produced more cost-effectively.

A battery housing is known from EP 2 467 253 B1, which housing has a plurality of housing parts. The housing parts delimit an inner volume of the battery housing and are connected to one another, for example, by means of a tongue and groove connection. The respective housing part is made up of several layers and has at least one carrier layer made of thermoplastic material and at least one cover layer made of metal, which are joined together in a sandwich-like manner. The cover layer primarily serves to mechanically stabilize the carrier layers. In addition, the cover layer results in electromagnetic shielding of the inner volume and thus of the battery cells accommodated in the battery housing.

A disadvantage of the solution known from the prior art is the insufficient electromagnetic compatibility of the battery housing and the battery, also known to those skilled in the art as “EMC”.

### SUMMARY

The present invention is therefore concerned with the task of specifying improved or at least different embodiments for a battery housing of the type mentioned at the outset and for a battery with such a battery housing, which are characterized in particular by improved electromagnetic compatibility and/or simplified manufacture.

According to the invention, this problem is achieved by the subject matter of the independent claim(s). Advantageous embodiments are the subject matter of the dependent claim(s).

The present invention is based on the general idea of assembling a battery housing from at least two housing parts, with each housing part being made of plastic and provided with a metal layer for electromagnetic shielding, and with the respective metal layer extending into the connection area of the housing parts, so that the metal layers contact each other in the connection area. This results in electrical contact between the metal layers in the connection area. Thus, an inner volume delimited by the housing parts is also electromagnetically shielded in the connection area and thus improved overall electromagnetic shielding with at the same time a simplified manufacture of the battery housing.

In accordance with the idea of the invention, the battery housing is designed in several parts, i.e. it has at least two housing parts which are connected to one another and delimit an inner volume of the battery housing. The inner volume serves in particular to accommodate at least one battery cell of an associated battery. In this case, the respective housing part has a connecting section, the connecting sections of the housing parts resting on one another and the housing parts being connected to one another via the connecting sections. The respective housing part has a base body made of plastic and a metal layer applied to the plastic for electromagnetic shielding of the inner volume. The respective metal layer extends into the connecting section of the associated housing part, so that the metal layers contact each other in the connecting sections resting on one another along the extension of the connecting sections.

In the present case, a metal layer is to be understood as meaning a layer made of a metal or a metal alloy which is applied to the base body and shields electromagnetic radiation.

The respective metal layer is expediently applied not only to the base body in the associated connecting section, but also outside of the connecting section. In this case, the respective metal layer can be applied to the inside of the base body facing the inner volume and/or to the outside of the base body facing away from the inner volume.

The respective metal layer is preferably applied to the outside of the associated base body facing away from the inner volume and extends, as described, into the connecting section. This prevents electrical interaction of the metal layer with components of the associated battery accommodated in the inner volume, in particular with battery cells accommodated in the inner volume. This means that other types of electrical insulation of the inner volume relative to the metal layer can be dispensed with, or at least they can be reduced. This results in simplified production of the battery housing and the associated battery.

The base body of the respective housing part is preferably the supporting component of the housing part. This means that the metal layer has no load-bearing function for the housing part and thus for the battery housing. The respective housing part and thus the battery housing, and consequently also the associated battery, is carried by the base bodies of the housing parts. The base bodies and the metal layers are designed accordingly with regard to their strength, material thickness and the like. In this case, the respective base body and thus the plastic is preferably considerably thicker than the metal layer in terms of material thickness.

In principle, the battery housing can have three or more housing parts.

The battery housing is advantageously designed in two parts, i.e. it has two housing parts. It is advantageous here if one of the housing parts is a lower housing part designed as a housing pot for accommodating battery cells of the battery and the other housing part is an upper housing part designed as a housing pot which closes the lower housing part.

In principle, the respective housing part can have other components in addition to the base body and the metal layer.

It is preferred if at least one of the housing parts, advantageously the respective housing part, consists of the base body made of plastic and the metal layer. This leads to simplified production and a reduced weight of the battery housing.

In advantageous embodiments, at least two of the metal layers in the connecting sections resting on one another rest on one another along the extension of the connecting sections. This results in a planar contact between the metal layers. This results in an improved electrical connection between the metal layers and consequently improved electromagnetic shielding of the inner volume. In this case, it is preferred if the metal layers rest on one another in all of the connecting sections that rest on one another along the extension of the connecting sections.

Embodiments are considered to be advantageous in which the metal layers extend over the respectively associated base body and make contact in such a way that they form a Faraday cage enclosing the inner volume. This is achieved in particular in that the metal layers contact each other in all connecting sections along the extension of the connecting sections, and in that the metal layers extend over the entire associated base body outside of the connecting sections. A particularly effective electromagnetic shielding and consequently a particularly effective electromagnetic compatibility of the battery housing and the associated battery are thus achieved.

In advantageous embodiments, at least two of the contacting metal layers in the connecting sections resting on one another extend transversely to the extension of the connecting sections only into a partial section of the respective associated connecting section. This means that the respective metal layer extends into a partial section of the associated connecting section, so that a remaining section of the connecting section is free of the metal layer. In this case, the partial section and the remaining section are preferably adjacent transversely to the extension of the connecting section. This is done in such a way that the base bodies and thus their plastic materials contact each other along the extension of the connecting sections in the remaining sections and the metal layers in the partial sections. This results in a defined connection between the housing parts. In addition, this results in simplified sealing of the inner volume from the environment.

It is advantageous here if the metal layers are applied to the outside of the base body and, starting from the outside, extend into the partial section of the connecting section, so that the remaining section is arranged on the side of the partial section facing the inner volume.

It is advantageous if at least two of the connecting sections resting on one another, preferably all of the connecting sections resting on one another, are pressed against one another. This leads to an improved connection of the housing parts and an improved sealing of the inner volume from the environment.

Embodiments are considered to be advantageous in which at least one of the housing parts has a sealing groove in the remaining section for receiving a seal. The seal is thus acted upon, in particular pressed, by the connecting sections at a distance from the metal layers and is at a distance from the metal layers. This leads to a predetermined and/or defined compression of the seal without causing damage to the metal layers and/or bulging of the metal layers and damage to the seal. This results in a simple and stable connection of the housing parts while at the same time reliably sealing the inner volume from the environment.

In principle, at least two of the housing parts can be permanently connected to one another via the connecting sections. In this context, materially integral connections between the connecting sections should be considered in particular.

It is preferred if at least two of the housing parts, advantageously all of the housing parts connected to one another, are detachably connected to one another. The battery housing can thus be opened if needed, for example in order to service and/or replace battery components accommodated in the inner volume.

The housing parts are preferably connected in a detachable manner by means of screw connections. This means that at least two of the at least two housing parts are screwed together. For this purpose, the connecting sections expediently have associated screw openings.

Embodiments are preferred in which the associated metal layers are recessed in the area of the screw openings. This means that the respective metal layer has a recess for the respective screw opening and is therefore at a distance from the screw opening. The recesses can be part of the remaining section or form it. This results in a defined connection of the housing parts to one another with a specified compression. In particular, in this way the screw connections can be tightened in a simple and reliable manner. The arrangement of the metal layers at a distance from the screw openings prevents metal layers from being present in the area of the screw openings and thus of the screw connection, which impair said pressing. In particular, this prevents or at least reduces deformation of the base body caused by the metal layers in the area of the screw openings and thus of the screw connection, in particular the penetration or impression of the metal layers into the base body due to the screw connection.

In preferred embodiments, at least one of the connecting sections resting on one another is shaped in a recessed manner, i.e. in particular depressed, in the direction away from the other connecting section. Advantageously, at least one of the base bodies in the connecting section is recessed in a direction away from the base body of the other, associated connecting section. Particularly preferably, at least one of the base bodies in the partial section of the connecting section is recessed in relation to the remaining section. A defined support of the connecting sections, in particular the base body, in the connecting sections and thus a defined compression of the connecting sections is thus achieved. In addition, bulging of the metal layers is avoided and/or compensated for in this way. The result is a simple and defined connection and pressing of the housing parts together.

Embodiments are considered to be advantageous in which the recess is adapted to the material thickness of the associated metal layer in such a way that the material thickness is compensated. The compensation is such that the associated connecting sections lie flat on one another along the extension in the partial sections and the remaining sections of the connecting sections. As a result, a precisely defined connection of the housing parts is achieved with improved sealing of the inner volume from the environment.

In principle, the respective connecting section can be configured and/or shaped as desired, provided that it can be connected to the associated connecting section of the other housing part.

It is preferred if at least one of the housing parts, advantageously a respective housing part, has a circumferential flange as a connecting section. Thus, the connecting section facing the other connecting section is planarly formed. Consequently, the associated metal layer can be applied to the connecting section in a simplified manner. In addition, this results in a simplified and defined connection of the connecting sections with simplified assembly. In this way, the housing parts and thus the battery housing can be manufactured and connected to one another in a simplified and defined manner.

At least one of the housing parts can have a base that is spaced apart from the connecting section and delimits the inner volume. It is preferred here if a flame-retardant fiber mat is attached between the base and the metal layer on the side facing away from the base of the housing part, i.e. on the outside of the base. As a result, the battery housing achieves improved protection of the components of the associated battery accommodated in the inner volume, in particular the battery cells, from the environment or vice versa.

Embodiments are preferred in which at least one of the metal layers, advantageously the respective metal layer, has a surface embossing. This leads to better contact of the metal layer on the base body even with uneven shapes and/or geometric shapes of the base body that deviate from a flat configuration. In particular in the transition area to the connecting section, an embossing leads to a simple and reliable support of the metal layer on the base body.

It is conceivable that the metal layer has a surface embossing only locally. It is also conceivable for the metal layer to have a surface embossing throughout.

In principle, the respective metal layer can have any desired configuration, provided that it leads to electromagnetic shielding.

The respective metal layer can be applied to the base body in any conceivable way.

It is conceivable to coat at least one of the base bodies with the metal layer.

It is conceivable to apply at least one of the metal layers to the associated base body in a materially integral manner. In particular, it is possible to glue the metal layer to the base body.

It is advantageous if at least one of the metal layers, in particular a respective metal layer, is designed as a metal foil applied to the base body, in particular in a materially integral manner. The metal layer can thus be applied to the base body in a simple and cost-effective manner and effective electromagnetic shielding can be achieved.

It is also conceivable to provide at least one of the metal layers as a metal fleece, a metal net, known in particular as a metal mesh, or a metal fiber.

Embodiments are conceivable in which the plastic of the base body is cast into the metal layer in such a way that the metal layer is arranged on the plastic of the base body. In particular, the metal layer can be placed as an insert in a casting mold for producing the base body. It is conceivable here to produce the base body by injection molding or by compression molding.

It is advantageous if the metal layer is designed in such a way that the plastic penetrates into the metal layer. In particular, the metal layer can be designed as a metal fleece, metal net, metal mesh and the like.

It goes without saying that, in addition to the battery housing, a battery with such a battery housing also belongs to the scope of this invention.

The battery has at least one battery cell, advantageously a plurality of battery cells, which are accommodated in the inner volume of the battery housing. The respective battery cell is designed to supply electrical energy.

The battery is preferably rechargeable. This means that the at least one battery cell is rechargeable.

In principle, the respective battery cell can have any configuration. In particular, the respective battery cell can be a pouch cell, a prismatic cell and the like.

In principle, the battery can be used in any application.

In particular, it is conceivable to use the battery in a motor vehicle. The battery can be used to drive the motor vehicle.

Further important features and advantages of the invention result from the dependent claims, from the drawings and from the associated description of the figures with reference to the drawings.

It goes without saying that the features mentioned above and those still to be explained below can be used not only in the combination specified in each case, but also in other combinations or on their own, without departing from the scope of the present invention.

Preferred exemplary embodiments of the invention are illustrated in the drawings and are explained in more detail in the following description, with the same reference numbers referring to identical or similar or functionally identical components.

### BRIEF DESCRIPTION OF THE DRAWINGS

In the drawing, schematically

FIG. 1 shows a section through a battery with a battery housing,

FIG. 2 shows an isometric partial view of a housing part of the battery housing,

FIG. 3 shows an isometric view of another housing part of the battery housing,

FIG. 4 shows an enlarged view of region IV in FIG. 3,

FIG. 5 shows an isometric view of a battery in another exemplary embodiment,

FIG. 6 shows an isometric view of a metal layer of a housing part of the battery of FIG. 5,

FIG. 7 shows an isometric view of a metal layer of another housing part of the battery of FIG. 5,

FIG. 8 shows another isometric view of the metal sheet of FIG. 7 in another exemplary embodiment.

### DETAILED DESCRIPTION

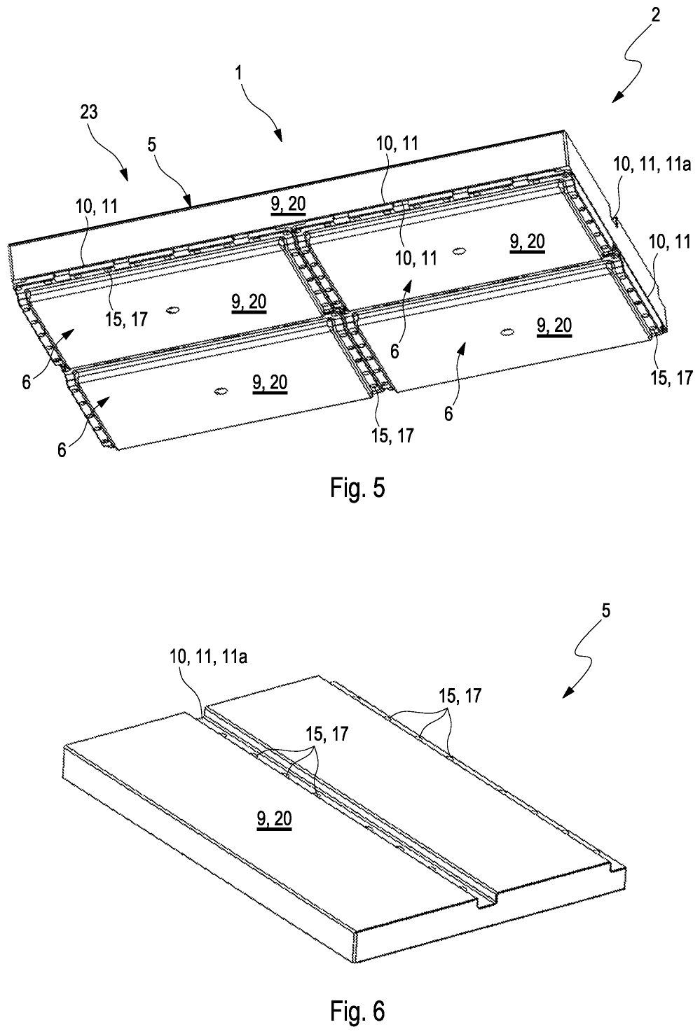

A battery housing 1, as shown for example in FIGS. 1 to 8, is part of a battery 2 shown in FIGS. 1 and 5. The battery housing 1 is used to accommodate battery cells 3 of the battery, shown only in FIG. 1. The respective battery cell 3 can be designed as a pouch cell 4, for example.

The battery housing 1 has a plurality of housing parts 5, 6 which are connected to one another and delimit an inner volume 7 of the battery housing. In the exemplary embodiments shown, the housing parts 5, 6 are detachably connected to one another. In the exemplary embodiments shown, the battery cells 3 of the battery 1 are accommodated in the inner volume 7.

In the exemplary embodiments shown, the battery housing 1 has at least one upper housing part 5, also referred to below as upper housing part 5, and at least one lower housing part 6, also referred to below as lower housing part 6. The at least one upper housing part 5 closes the at least one lower housing part 6, the at least one upper housing part 5 delimiting the inner volume 7 together with the at least one lower housing part 6. The at least one upper housing part 5 and the at least one lower housing part 6 are arranged opposite one another and are connected to one another. In the exemplary embodiments shown, the at least one upper housing part 5 and the at least one lower housing part 6 are detachably connected to one another.

The respective housing part 5, 6 has a supporting body 8 made of plastic. In addition, the respective housing part 5, 6 has a metal layer 9 made of a metal or a metal alloy attached to the base body 8. The metal layers 9 of the housing parts 5, 6 serve to electromagnetically shield the inner volume 7 from the environment and thus ensure electromagnetic compatibility of the battery housing 1 and the associated battery 2. The housing parts 5, 6 each have a connecting section 10. The connecting sections 10 of associated housing parts 5, 6 rest on one another, with the associated housing parts 5, 6 being connected to one another by means of the connecting sections 10. The respective base body 8 is made of plastic. In the exemplary embodiments shown, the respective housing part 5, 6 consists of the base body 8 and the metal layer 9.

As can be seen from FIGS. 1 to 8, in the exemplary embodiments shown, the respective metal layer 9 extends outside of the connecting sections 10 over the entire outer side 12 of the associated base body 8, facing away from the inner volume 7. In contrast, the respective inner side 13 of the respective base body 8, facing the inner volume 7, is free of metal layers 9 outside of the connecting sections 10. This means that the inner volume 7 is delimited by the base bodies 8 and thus by plastic.

In the exemplary embodiments shown, the respective housing part 5, 6 has a connecting section 10 designed as a flange 11, the at least one upper housing part 5 being connected to the at least one lower housing part 6 by means of the flanges 11.

In the exemplary embodiments shown, the respective housing part 5, 6 has a base 24 which delimits the inner volume 7 and is at a distance from the flange 11.

As can also be seen from the figures, in the exemplary embodiments shown, the respective metal layer 9 extends into the connecting section 10 of the associated housing part 5, 6, so that the metal layers 9 in the connecting sections 10 resting on one another along the extension of the connecting sections 10 make contact with one another. A Faraday cage 23 enclosing the inner volume 7 is thus created by means of the metal layers 9 for achieving an electromagnetic shielding of the inner volume 7. In the exemplary embodiments shown, the metal layers 9 extend into the associated connecting sections 10 in such a way that the metal layers 9 lie flat on each other at least in the area of the flanges 11. This achieves an improved electrical connection between the metal layers 9 and thus an improved electromagnetic shielding.

As only shown in FIG. 1, in the exemplary embodiments shown, the flanges 11 are prestressed against one another by means of a screw connection 14 and the flanges 11 are thus pressed against one another. For this purpose, the connecting sections 10 screwed together have associated screw openings 15 through which a screw 16 is passed. In the exemplary embodiments shown, the respective metal layer 9 is cut out in the area of the screw openings 15. This means that the respective metal layer 9 has a recess 17 for the respective associated screw opening 15.

In the exemplary embodiments shown, the respective metal layer 9 is in the form of a metal foil 20.

FIGS. 1 to 4 show a first exemplary embodiment of the battery housing 1 and the battery 2. In the exemplary embodiment shown in FIGS. 1 to 4, the battery housing 1 has an upper housing part 5 and a lower housing part 6.

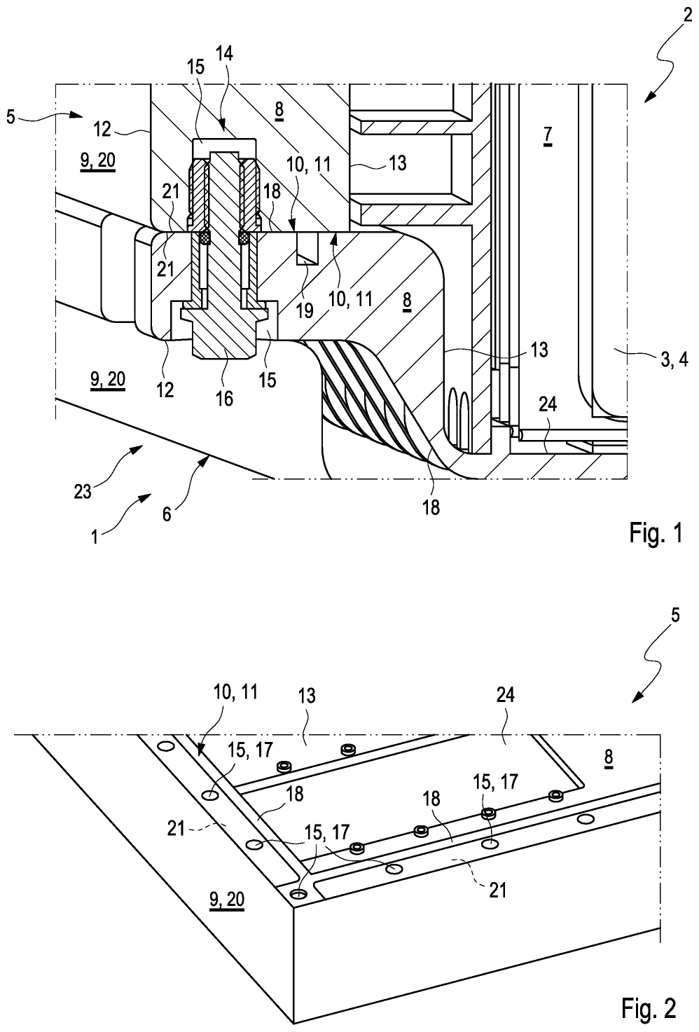

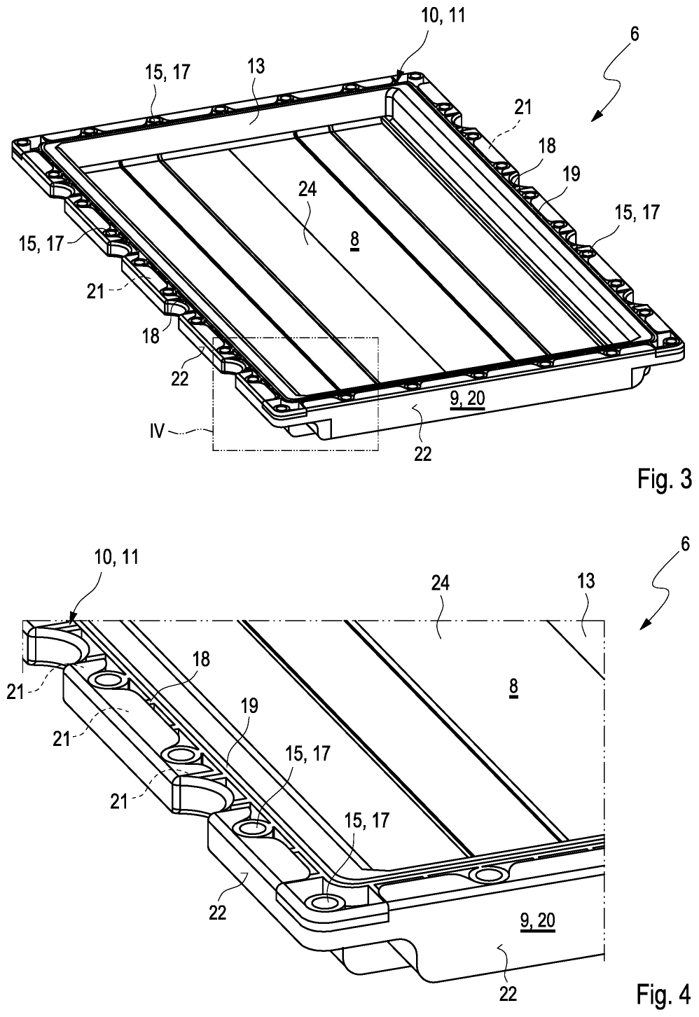

FIG. 2 shows an isometric partial view of the upper housing part 5. FIG. 3 shows an isometric view of the lower housing part 6 and FIG. 4 shows an enlarged view of region IV in FIG. 3.

As can be seen in particular from FIGS. 2 to 4, the respective metal layer 9 extends over a partial section 21 of the connecting section 10 designed as a flange 11, so that a remaining section 18 of the connecting section 10 is free of the metal layer 9. The partial section 21 is thus formed by the metal layer 9 on the outside. In contrast, the remaining section 18 is formed on the outside of the base body 8 and is thus made of plastic. In the exemplary embodiments shown, the remaining section 18 is arranged between the partial section 21 and the inner volume 7 when the housing parts 5, 6 are connected to one another.

As can be seen in particular from FIG. 1, in the remaining sections 18, which are free from the metal layer 9, the base bodies 8 and thus the plastic materials lie on one another and are pressed against one another. As can also be seen in particular from FIGS. 1 and 4, at least one of the housing parts 5, 6, the housing lower part 6 in the exemplary embodiments shown, has a sealing groove 19 in the remaining section 18, which serves to accommodate a seal (not shown). In the exemplary embodiments shown, the sealing groove 19 is a continuous closed sealing groove 19. The seal, not shown, which is accommodated within the groove 19, is pressed by means of the remaining sections 18 of the connecting sections 10. Together with the compression of the connecting sections 10, an effective sealing of the inner volume 7 to the outside is thus achieved. The arrangement of the metal layers 9 at a distance from the screw openings 15 and the fact that the remaining sections 18 are free from the metal layer 9 result in a defined pressing of the connecting sections 10 against one another. In addition, this prevents the metal foils 20 from forming bulges and/or penetrating in the base body 8 in the area of the flanges 11.

As can be seen from FIG. 1, at least one of the base bodies 8, advantageously the respective base body 8, is recessed and thus depressed in the region of the respective flange 11 away from the opposite base body 8. The respective base body 8 is preferably designed to be recessed in the partial section 21. In the area of the partial section 21 and thus outside the respective remaining section 18, this leads to a compensation of the existing material thickness of the metal layer 9, so that the flanges 11 are evenly pressed against one another.

FIGS. 5 to 8 show other exemplary embodiments of the battery housing 1 and of the battery 2. With the exception of the differences mentioned below, these exemplary embodiments correspond to the exemplary embodiment of FIGS. 1 to 4.

In the exemplary embodiments shown in FIGS. 5 to 8, the battery housing 1 has a plurality of lower housing parts 6 and a common upper housing part 5. In the exemplary embodiments shown in FIGS. 5 to 8, the battery housing 1 has a total of four lower housing parts 6 and a common upper housing part 5. The respective lower housing part 6 corresponds to the lower housing part 6 of the exemplary embodiment in FIGS. 1 to 4. The lower housing parts 6 are arranged next to one another. The common upper housing part 5 closes the lower housing parts 6. The respective lower housing part 6 has an end face 22 facing the respective adjacent lower housing part 6. The mutually facing end faces 22 can each form a connecting section 10 over which the metal layer 9 extends entirely. In the connecting sections 10 formed by the end faces 22, the metal layers 9 of the different lower housing parts 6 can therefore lie flat on one another.

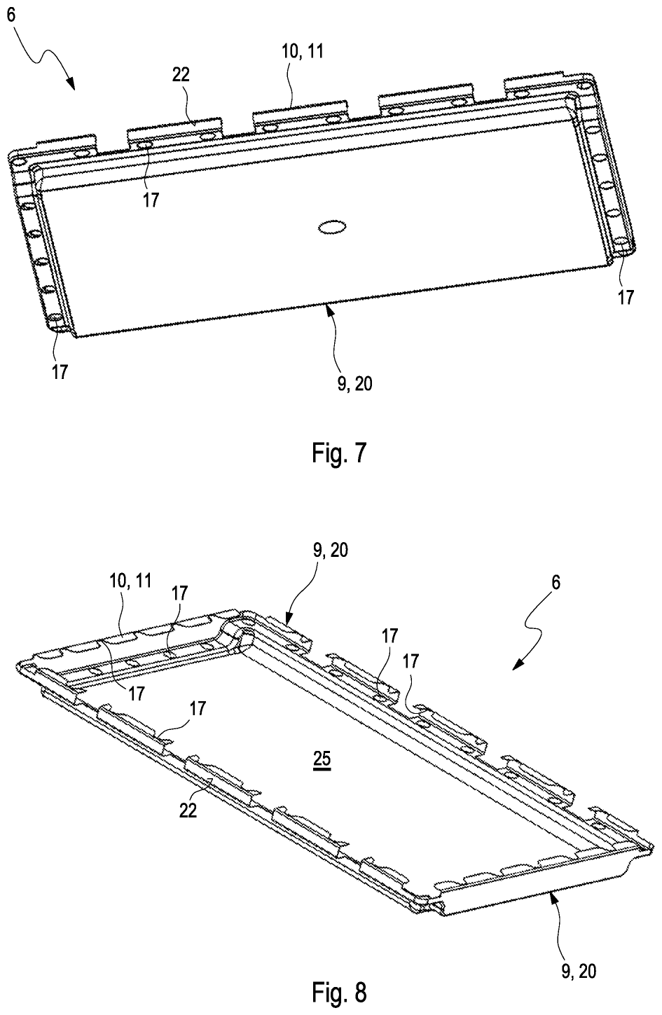

FIG. 6 shows an isometric view of the upper housing part 5. FIG. 7 shows an isometric view of the metal layer 9 of one of the lower housing parts 6. FIG. 8 shows an isometric view of the metal layer 9 from FIG. 7 in another exemplary embodiment.

As can be seen in particular from FIG. 6, the upper housing part 5 of this exemplary embodiment has at least one common connecting section 10 for the lower housing parts 6. The upper housing part 5 of the exemplary embodiments shown in FIGS. 5 to 8 has a circumferential flange 11 and a further, longitudinally extending and centrally arranged connecting section 10, which is also designed as a flange 11, wherein this flange 11 of the upper housing part 5, hereinafter also referred to as middle flange 11a, is free from the metal layer 9 of the upper housing part 5.

The respective metal foil 20 preferably has a surface embossing (not visible). The surface embossing allows an easier deformation of the respective metal foil 20 and thus a complete surface contact of the metal foil 20 on the associated base body 8.

As can be seen in particular from FIG. 8, a flame-retardant fiber mat 25 can be arranged between the metal foil 20 and the base body 8 in at least one of the housing parts 5, 6 on the side of the base 24 facing away from the inner volume 7.

As can be seen in particular from FIGS. 2 to 4, the base body 8 and thus the plastic can be cast into the associated metal foil 20, in particular by injection molding and/or compression molding.

1. A battery housing for accommodating battery cells of a battery, comprising:
at least two housing parts delimiting an inner volume;
each housing part of the at least two housing parts having a connecting section;
the connecting sections of the at least two housing parts resting on one another;
the at least two housing parts connected to one another via the connecting sections;
each housing part of the at least two housing parts having a plastic base body and a metal layer disposed on the base body for electromagnetic shielding of the inner volume; and
the metal layer extends into the connecting section of the corresponding housing part such that the metal layers, in the connecting sections resting on one another, contact each other along an extension of the connecting sections.

2. The battery housing of claim 1, wherein at least two of the metal layers in the connecting sections resting on one another rest on one another along the extension of the connecting sections.

3. The battery housing of claim 1, wherein the metal layers contact each other such that the metal layers form a Faraday cage enclosing the inner volume.

4. The battery housing of claim 1, wherein:
at least two of the metal layers contacting one another in the connecting sections resting on one another extend transversely to the extension of the connecting sections into a partial section of the respective corresponding connecting section such that the respective connecting section is free of the metal layer in a remaining section; and
the base bodies contact each other in the remaining sections of the connecting sections along the extension of the connecting sections.

5. The battery housing of claim 4, wherein at least one of the connecting sections includes a sealing groove disposed in the remaining section, the sealing groove configured to accommodate a seal.

6. The battery housing of claim 1, wherein the connecting sections resting on one another are pressed against one another.

7. The battery housing of claim 1, wherein the at least two housing parts are detachably connected to one another.

8. The battery housing of claim 7, wherein:
the at least two housing parts are detachably connected to one another via at least one screw;
the connecting sections have associated screw openings for receiving the at least one screw; and
the metal layers are recessed in an area of the screw openings.

9. The battery housing of claim 1, wherein at least one of the connecting sections resting on one another is recessed in a direction away from the other connecting section.

10. The battery housing of claim 1, wherein at least one of the at least two housing parts includes a peripheral flange that defines the connecting section.

11. The battery housing of claim 1, wherein:
at least one of the at least two housing parts has a base which is disposed spaced apart from the connecting section and delimits the inner volume; and
on a side facing away from the base, a flame-retardant fiber mat is arranged between the base and the metal layer.

12. The battery housing of claim 1, wherein at least one of the metal layers is embossed.

13. The battery housing of claim 1, wherein at least one of the metal layers is configured as a metal foil.

14. The battery housing of claim 1, wherein the plastic base bodies are cast into the associated metal layer.

15. A battery, comprising:
the battery housing of claim 1; and
at least one battery cell accommodated in the inner volume.

16. The battery housing of claim 1, wherein the metal layers are disposed on an outer side of the associated base body facing away from the inner volume and extend into the connecting section.

17. A battery housing, comprising:
a first housing part including a first plastic base body and a first metal layer arranged on the first base body, a first metal layer portion of the first metal layer disposed on a first connecting section of the first base body;
a second housing part including a second plastic base body and a second metal layer arranged on the second base body, a second metal layer portion of the second metal layer disposed on a second connecting section of the second base body;
the first connecting section and the second connecting section arranged on one another and detachably connecting the first housing part and the second housing part to one another such that the first housing part and the second housing part delimit an inner volume that is electromagnetically shielded via the first metal layer and the second metal layer; and
wherein the first metal layer portion and the second metal layer portion contact each other along an extension of the first connecting section and the second connecting section such that the first metal layer and the second metal layer form a Faraday cage enclosing the inner volume.

18. The battery housing of claim 1, wherein:
the first metal layer is disposed on an exterior surface of the first base body and wraps at least partially around the first connecting section such that the first metal layer portion is disposed on a surface of the first connecting section facing the second housing part; and
the second metal layer is disposed on an exterior surface of the second base body and wraps at least partially around the second connecting section such that the second metal layer portion is disposed on a surface of the second connecting section facing the first housing part.

19. The battery housing of claim 18, wherein the second housing part further includes a peripheral flange that defines the second connecting section.

20. A battery housing, comprising:
a first housing part including a first plastic base body and a first metal layer arranged on the first base body, a first metal layer portion of the first metal layer disposed on a first connecting section of the first base body;
a plurality of second housing parts each including a second plastic base body and a second metal layer arranged on the second base body, a second metal layer portion of the second metal layer disposed on a second connecting section of the second base body;
the plurality of second housing parts arranged on the first housing part such that each second housing part of the plurality of second housing parts and the first housing part define a respective inner volume that is electromagnetically shielded via the first metal layer and the respective second metal layer;
each second housing part of the plurality of second housing parts detachably connected to the first housing part via the respective second connecting section and the first connecting section;
wherein the second metal layer portion of each of the plurality of second housing parts contacts the first metal layer portion to form a Faraday cage enclosing the respective inner volume.
